(19) United States
(12) Patent Application Publication
(10) Pub. No.: US 2004/0236723 A1
(43) Pub. Date: Nov. 25, 2004

(54) Method and system for data evaluation, corresponding computer program product, and corresponding computer-readable storage medium

(76) Inventor: Marc Andre Reymond, Helmstedt (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/488,165

(22) PCT Filed: Aug. 30, 2002
(86) PCT No.: PCT/EP02/09735

(30) Foreign Application Priority Data
Aug. 30, 2001 (DE) 101 43 712.9

(51) Int. Cl. G06F 7/00

(52) U.S. Cl. 707/2

(57) ABSTRACT

The invention relates to a method and a system for data evaluation, to a corresponding computer program product, and to a corresponding computer-readable storage medium, which can be especially used as an internet-based, patient-specific prognosis system. In this case, clinical, pathological and molecular biological data can be integrated, and said data can be combined with relevant prognoses for a particular patient. The system thus enables an oncologist, for example, to decide on an individual treatment on the basis of a specific information pattern. The quality of the prognosis is improved by determining significant and secondary variables, leading to a clear reduction in the quantity of data to be evaluated, to the acceleration of the data evaluation and to the improvement of the prognosis.

### DESCRIPTION

The invention relates to a process and an arrangement for data evaluation as well as a corresponding computer program product and a corresponding computer-readable storage medium, which can be used in particular as an Internet-based patient-specific prognosis system. In this case, the integration of clinical, pathological and molecular biological data is made possible, as well as the linkage of these data with relevant prognostic information in a specific patient. As a result, the system allows, for example, an oncologist to make an individual therapeutic decision based on a specific information pattern.

Information technology (IT) is becoming increasingly important in medicine. Nevertheless, patient supply is only inadequately supported as a nuclear process in public health services at this time. Instead, administrative activities are emphasized. The potential of this technology, however, allows the provision of a better-quality patient supply in the case of simultaneous economic use of the existing resources.

Reliable prognostic information forms an important component of an improved patient supply. A prognosis can be made, however, not only based on general knowledge of disease and patient; in addition, information on the prior course of the disease in any individual patient is also important. In this case, accurate clinical-pathological data and information on aftercare play a very important role. Here, for example, the iterative nature of the prognostic determination must be considered.

In addition to the exact knowledge of the patient and his disease, it is also important to compare this case with similar cases in the past at in-house or outside institutions, and the experiences at that time can be considered. Such comparisons can only be made, however, with high-quality referral databases.

Prognostic statements are of major importance in particular in cancer to determine the best possible therapy. The importance arises from the fact that cancer has a developing and individual clinical picture unlike a virus, which causes the same symptoms in any patient. In these diseases, the following facts are important for prognostic statements:

Patient information such as age, co-morbidity rate, reliability, etc.,

Peripheral information, such as surgery, initial treatment, insurance system, country, etc.,

Tumor information such as pathology, tumor staging, mutations, gene expression on the level of transcription and proteome.

To learn this “art of prediction,” it is important to start from the patient. Which questions relate to the patient? What does he want to know from the physician? In this connection, the following questions are those most frequently asked by patients—in accordance with an opinion poll:

To what extent will a treatment heal me?

How long is the normal life-span with treatment?

Will I die if I am not treated?

How quickly will the disease spread if I am not treated?

The staging systems that are now available (such as, e.g., the tumor node metastasis system of the International Union Against Cancer—UICC) already allow statements for patient groups, but not, unfortunately, for a specific patient. In the prognosis, however, information must be related to each individual patient, taking into consideration his specific situation, while in the diagnosis, the special thing is generalized and neglected. Henceforth, modem findings from tumor-gene expression research must be considered in addition to make possible this step from diagnosis to patient-specific prognosis—and thus an individual therapy—an object that has not yet been achieved.

An additional unsolved problem in the conventional systems exists in the assimilation of the considerable amounts of data that must be evaluated for a high-quality prognosis. The latter can no longer be managed by the physician (oncologist) alone in the case of therapy decisions. Also, the currently available computer technology and the programs that are used for data evaluation are not suitable to evaluate these amounts of data—especially provided by the molecular-biological databases—within a reasonable time.

The drawbacks of the existing solutions in this field are recognized by the leading cancer associations. For example, all patients with colorectal carcinoma in UICC Stage 3 are given adjuvant treatment according to the guidelines of the consensus conferences after curative surgery, even if only 40% metachronous satellite metastases develop. This results in superfluous side effects for the patients and in considerable additional costs for the health system. On the other side, 8% of patients in Stage I and 14% of patients in Stage II develop satellite metastases that do not receive any adjuvant chemotherapy according to guidelines, which results in an elevated cancer mortality rate (Kockerling, Reymond et al., J Clin Oncol, 1998).

The establishment of an Internet-based medical information system for physicians has been marked as a necessary support of medical services. The American Cancer Society (http://www3.cancer.org/cancerinfo/cancer_profiler.asp) and other organizations such as the European School of Oncology (www.cancerworld.org/progetti/cancerworld/start/pagine/Homeframe.html), the University of Pennsylvania (www.oncolink.upenn.edu/resources/physicians) and others (e.g., http://www.cancerhome.com) already offer Internet portals now to support, e.g., the oncologists.

All of these portals, however, present only the current guidelines and recommendations from the expert conferences and therefore do not provide any solution to the above-mentioned problem. In addition, these patient pages can be called up; this should not happen according to the HON Code of Conduct (HONcode) for medical websites in the field of health: “The information on the website is applied such that it supports the existing physician-patient relationship and in no way replaces it.” (http://www.hon.ch/HONcode/German/).

In addition, no e-health product has yet been added to the market that associates molecular biological data with conventional clinical and pathological information to support the physician in therapy decisions for cancers. Only the many different possible therapies need to be selected, and they contain the amount of information that is to be assimilated to emphasize the necessity of such a system.

An information system in the market preparation test phase, in which neuronal networks or rule-based systems are used for the generation of prognostic statements, is known. In this connection, several thousand data sets (sets) of prospective patient data are considered for the evaluation. With a large portion of these data sets, which in each case consist of far more than one-hundred parameters (variables) for thousands of patients, the information system was trained. An additional number of data sets of Oust one thousand) randomly selected patients, which were not used for training the neuronal network, were used for examining the system.

This system makes possible a prediction of the chances of survival of a patient after curative colorectal surgery with a predictive value of about 90%. For the metastasizing, the system still cannot reproduce this good prognostic statement. Here, obviously additional molecular-biological data are necessary to improve the output. The following variables come out as the most significant: depth of tumor infiltration, T-category, tumor-free resection edges, grading, and venous and lymphatic invasion.

The object, which is to be achieved by the invention, consists in providing an improved process for data evaluation. The purpose is the broadening of the informative value (which was previously possible only for patient groups) in the prognoses for an individual patient (e.g., with respect to the risk of metastasizing, therapeutic response to a number of chemotherapy agents, and predictions of side effects). In addition, the significance of the parameters considered in the evaluation is to be considered by the invention, and thus a reduction of the amounts of data that are necessary for the prognosis are achieved, without the quality of the prognosis being reduced.

This object is achieved according to the invention by the features in the characterizing part of claims 1, 13, and 15 to 25 in working together with the features in the introductory clause. Suitable embodiments of the invention are contained in the subclaims.

A special advantage of the invention lies in that in the process for data evaluation with use of data processing devices that are coupled to databases, the amounts of data that must be considered for a high-quality evaluation, such as, e.g., a medical prognosis, are quite considerably reduced if the query data fed to the data processing device are analyzed by ensuring that the data that are stored in the database(s) are obtained according to rules that can be specified in advance and/or corresponding to the query data with artificial intelligence procedures, the quality of these corresponding data is evaluated automatically, and based on the evaluation thereof, the related query data and/or corresponding data automatically determine for the query the significance of these query data and/or corresponding data, and the results of the evaluation, the evaluation of the quality, and/or the significance of the data is output and/or provided in a form that is ready for recall.

An arrangement for data evaluation is advantageously set up such that it comprises at least one processor, which is (are) set up such that a process for data evaluation can be performed, whereby the query data fed to the data processing device are analyzed by ensuring that the data that are stored in the database(s) are obtained according to rules that can be specified in advance and/or corresponding to the query data with artificial intelligence procedures, the quality of these corresponding data is evaluated automatically, and based on the evaluation thereof, the related query data and/or corresponding data automatically determine for the query the significance of these query data and/or corresponding data, and the results of the evaluation, the evaluation of the quality, and/or the significance of the data is output and/or provided in a form that is ready for recall.

A computer program product for data evaluation comprises a computer-readable storage medium, on which a program is stored, which makes it possible for a computer, after it has been stored in the memory of the computer, to perform a process for data evaluation, whereby the data evaluation comprises the process steps according to one of claims 1 to 12.

To perform an automatic data evaluation, advantageously a computer-readable storage medium is used on which a program is stored that makes it possible, after it has been stored in the memory of the computer, for a computer to perform a process for data evaluation, whereby the data evaluation comprises the process steps according to one of claims 1 to 12.

A method for using a system for data evaluation consists in that the access to the system is made possible by a PIN that is subject to fees, whereby the PIN is associated with agents for detecting data that is to be input into the system and/or with agents for detecting material that is used to determine the data that is being input, and the user acquires the PIN by paying a fee.

In a preferred embodiment of the invention, it is provided that the data evaluation generates medical prognoses and the query data are fed to the data processing device as clinical-pathological data by a physician and/or as biomolecular data by an analysis laboratory. In this case, it is advantageous if the query data and/or the data that are stored in the database(s) are considered as disease-related factors and/or patient-specific factors and/or environment-specific factors. In particular, tumor-specific factors are also considered under the disease-related factors.

Moreover, it has proven to be advantageous that an updating of the empirical data stored in the database(s) is carried out by having data on the therapy and the course of the disease be fed to the data processing device in cases forecast by the data processing device. It is also provided that an updating of the evaluation instructions in an iterative learning process is carried out, in which queries, query data, used in the evaluation of queries, data stored in the database(s), results of the evaluation and events actually occurring are considered.

It is especially advantageous if, based on the evaluation, the amount of the data that is stored in the database(s) is reduced and/or the number of query data to be supplied and/or the amount of the data that is stored in the database(s) is reduced based on the significance.

In a preferred embodiment of the invention, it is provided in addition that the evaluation by cluster analysis, similarity tests, tendency analysis, correspondence analysis, rising hierarchical classification, main analysis and/or wavelet analysis is carried out in connection with probability values that are generated from error models and/or agents of artificial intelligence such as neuronal networks and/or rule-based systems.

Moreover, it has proven advantageous that the data evaluation comprises the determination of the initial probability of events referred to by the query and/or by the corresponding data.

A reduction of the data that is to be processed can be achieved by the significance of data being determined such that a query is evaluated a first time without considering this data and a second time while considering this data, the evaluations of the results of these two evaluations are compared to one another, and the measurement of the influence of the data relative to an improvement or a worsening of the second evaluation relative to the first evaluation is determined, and in the case of an improvement of the second evaluation compared to the first evaluation, the data are considered to be significant, and are considered in future evaluations, in the case of a worsening of the second evaluation compared to the first evaluation, the data are regarded as not significant and are no longer used for future evaluations.

The availability of clinically relevant knowledge regarding a specific medical problem in the workplace of the physician (oncologist) is considerably improved by the invention, for example, by the supply of data, the queries and/or the release of the results being carried out over the Internet. Access to data that originate from various databases is obtained via the computer system (that can be reached by the Internet), but were set up, e.g., by the use of the Internet standard XML (eXtensible Markup Language) on a uniform basis. The different formats and data structures can no longer be recognized for it. As a result, it is possible to permanently influence the acceptance and the actual influence of gene expression data on the patient supply. By this standardization of the language or formats of the data, the organizational requirements for successful use of the invention are provided.

For the efficient use of the invention, an arrangement is provided that comprises the following:

at least one data processing device that is coupled to at least one database,

agent for data input and/or data output,

agent working according to rules that can be specified in advance and/or with artificial intelligence procedures for determining data that corresponds to query data fed to a data processing device and stored in the database(s),

agent for automatic evaluation of the quality of the corresponding data,

agent for automatic determination of the significance of the query data or corresponding data for a query.

The invention allows the estimate of the risk of metastasizing of an individual patient such that the indication of an adjuvant chemotherapy can be set specifically. In addition, an estimate of the probability of the therapeutic response in the case of a number of chemotherapy agents is made possible, such that a tumor resistance pattern can also be detected with a corresponding tumor profiling. By the selection of the molecular targets (on DNA, RNA and protein levels), which are associated with a specific clinical outcome (e.g., metastasizing), a quite considerable reduction of data is achieved, which must be evaluated for a high-grade prognosis. Only the outcome-relevant molecules are considered, which represents a decisive step in the direction of validating potential drug targets in human patients. As an additional advantage of the invention, it can be regarded that the risk of unsuccessful, costly therapy tests drops considerably, the development costs of a medication are reduced, and thus the health costs are decreased, since it is possible to determine patient populations that are best suited for clinical studies with a specific chemotherapy agent. With the aid of the invention, it is to be possible to evaluate whether an additional therapy results in a considerable improvement of the prognosis, e.g., compared to the pool of patients who had been treated with adjuvant therapy. Because of this specific information pattern, the physician is put in the position of making an individual therapy decision—i.e., a decision relative to a specific clinical picture or stage of disease.

By use of the invention, prospectively randomized studies could possibly be replaced by high-value evidence-based data. This would be an additional advantage since the implementation of numerous randomized studies in an increasing number of cancer therapies is associated with considerable costs and organizational difficulties, which thus could be spared.

The use of a process according to one of claims 1 to 12 has proven advantageous for

evaluating clinical, pathological and/or molecular-genetic data,

determining the prognostic significance of clinical, pathological and/or molecular-genetic data,

selection of molecular targets,

estimating the individual risk, such as, for example, the risk of metastasizing of individual patients,

estimating the probability of the therapeutic response to, e.g., chemotherapy agents and/or

automatic generation of prognostic and/or therapy proposals.

An improvement of patient-specific prognoses can be expected by data, genes, molecular and/or genetic targets being used, which are made available by a process according to one of claims 1 to 12, by an arrangement according to one of claims 13 or 14, by a computer program product according to claim 15, by a computer-readable storage medium according to claim 16 or a use according to claim 17.

Preferred for diagnostic arrangements are therefore production processes that comprise the steps of a process according to one of claims 1 to 12 and one additional step, in which a diagnostically effective analytical tool, such as, e.g., an RNA chip or a protein chip and/or a combination of genes, which were made available by a process according to one of claims 1 to 12, by an arrangement according to one of claims 13 or 14, by a computer program product according to claim 15, by a computer-readable storage medium 16 or a use according to claim 17, is put together.

In the same manner, an advantage is produced in using genes or combinations of genes, which were made available by a process according to one of claims 1 to 12, by an arrangement according to one of claims 13 or 14, by a computer program product according to claim 15, by a computer-readable storage medium according to claim 16 or a use according to claim 17, for the preparation of a diagnostic compilation for classification of genetically induced diseases, tumors, i.a., and/or for predicting genetically induced diseases and/or for combining molecular-genetic parameters with clinical parameters and/or for identification of tumors by gene expression profiles.

For the performance of laboratory tests, for example, it has proven advantageous to use carrier elements on which data, genes, molecular and/or genetic targets are provided, which are made available by a process according to one of claims 1 to 12, by an arrangement according to one of claims 13 or 14, by a computer program product according to claim 15, by a computer-readable storage medium according to claim 16 or a use according to claim 17.

In a preferred embodiment of the carrier element, it is provided that the carrier element is designed as a chip, and provides

data regarding individual risk, such as, e.g., metastasizing potential, and/or

data on the therapeutic response to, e.g., chemotherapy agents and/or

data for patient metabolism and/or

information on autoimmunity, e.g., anti-tumor autoimmunity.

The carrier element is preferably designed as a reproducible chip.

Findings from (Internet) management and quality control for e-health systems show that the objective, which is assimilated by the invention, requires a problem-oriented production, which is not oriented only to a strictly scientific organization, such as the gene expression data network. Rather, it is necessary—and the invention meets this requirement—with the aid of a well-structured design, to provide a basis for the production of larger frameworks and the showcasing of methods and techniques, which makes it possible for the physician (oncologist), in addition to an individual therapy decision, to also be able to form his own practical sets of solutions based on the knowledge that is imparted.

For the commercial use of the invention, it has proven advantageous if the user acquires the PIN together with the agent(s) for detecting the data and/or the material when buying this (these) agent(s).

Another possibility for using the system for data evaluation consists in the fact that a distributor of the system for data evaluation reaches an agreement of use with at least one customer, and the customer(s) makes (make) the system usable for additional subscribers by issuing PINs that are subject to fees.

It is provided in particular that referral laboratories, pharmaceutical firms and/or content providers use the system for data evaluation as customers.

In a preferred variant of the commercial use, it is provided that the fees for the use of the system for data evaluation be raised from the customer and be collected

for each use and/or

as a percentage in the sales that the customer makes with the system and/or

per PIN that is issued.

Another form of commercial use consists in that a user of the system for data evaluation acquires the PIN from a distributor of the system or from a customer of the operator.

It has proven advantageous if an agent for detecting material is a carrier chip for the samples that are required in a laboratory test—that can be reproduced, if necessary —such as, e.g., a DNA-microarray.

With respect to data protection, it has proven advantageous if a PIN is linked to data that can be specified in advance and that is stored in the system, and the PIN only facilitates access to the latter with its linked data.

Another advantage consists in the use of a system for data evaluation according to one of claims 1 to 32 for implementing profit or non-profit actions by physicians, patients and/or firms that operate the system, whereby an action is initiated by subscribers and/or suppliers of the system. Such actions can contain, for example, the exchange of information and/or the introduction of customer and/or patient groups. In particular, such a use of the system for data evaluation is useful if the actions comprise the development, maintenance, and/or marketing of an excellence network and/or the distribution of therapies and/or the selection of patient groups for clinical studies. Thus, for example, when the system is used in the Internet, this can ensure that the visitors' loyalty is attached to the corresponding Web pages and/or a certain customer group is tied to the system.

The invention is to be explained in more detail below based on the embodiments that are depicted at least partially in the figures.

Here:

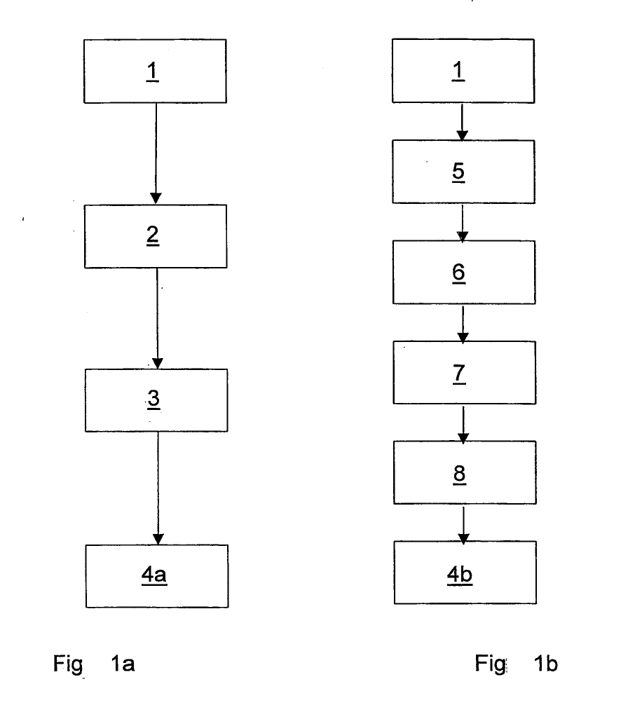

FIG. 1a shows a diagrammatic visualization of the process steps in conventional data evaluation,

FIG. 1b shows a diagrammatic visualization of the process steps in data evaluation according to the invention,

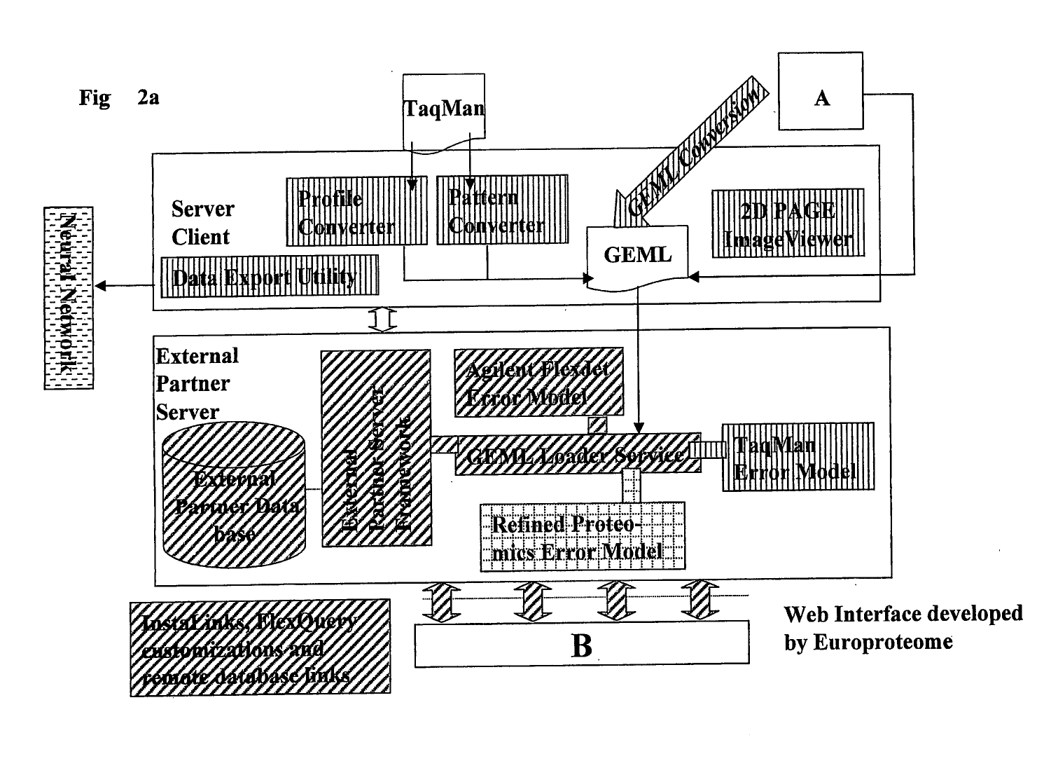

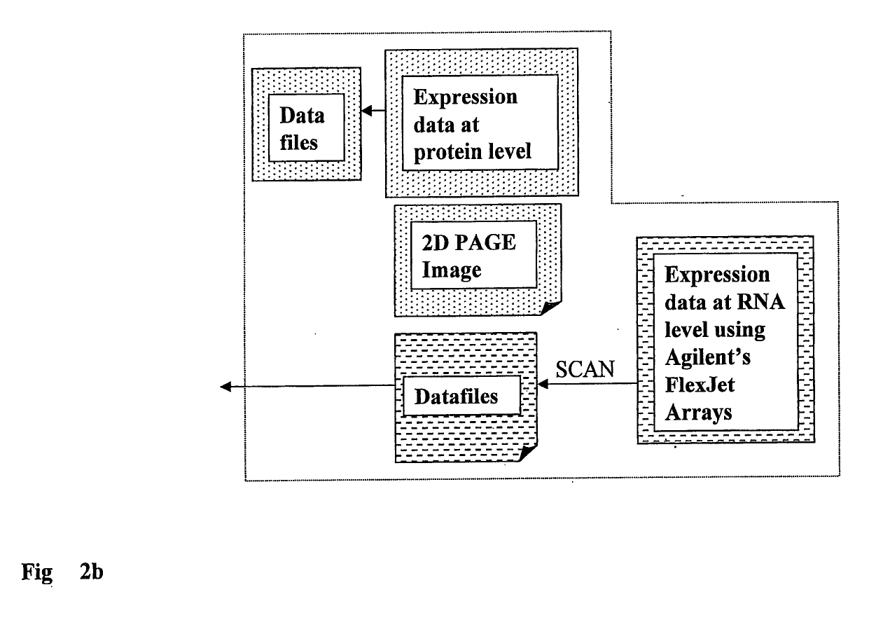

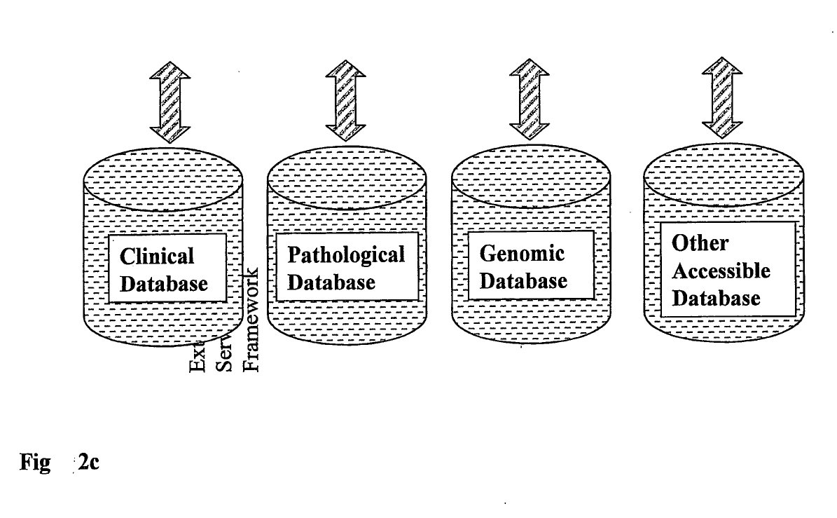

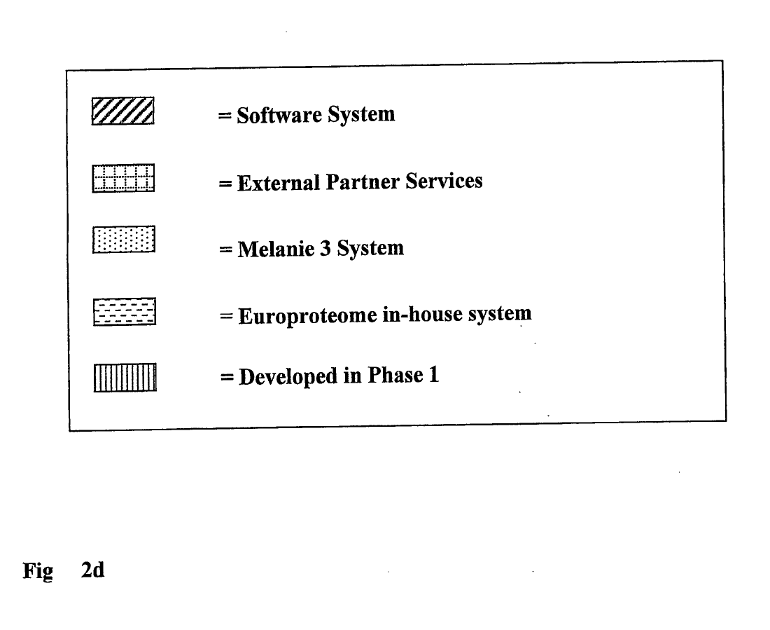

FIGS. 2a-d show a visualization of the modular design of a medical information system,

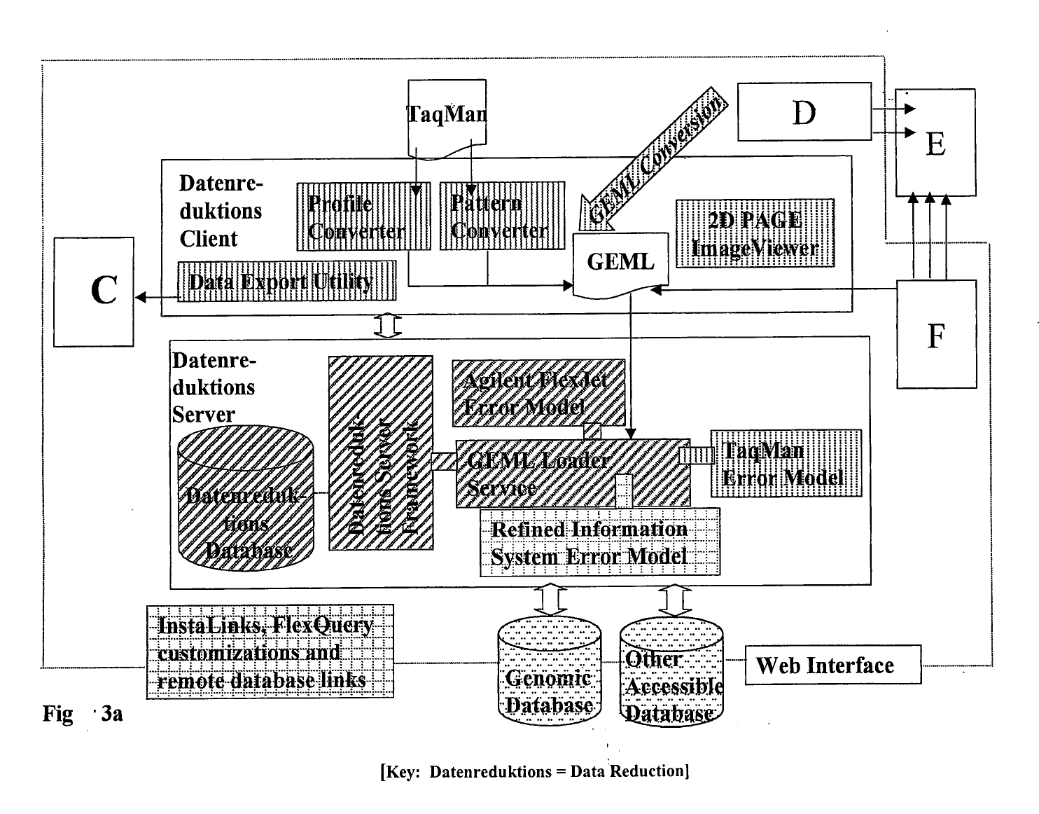

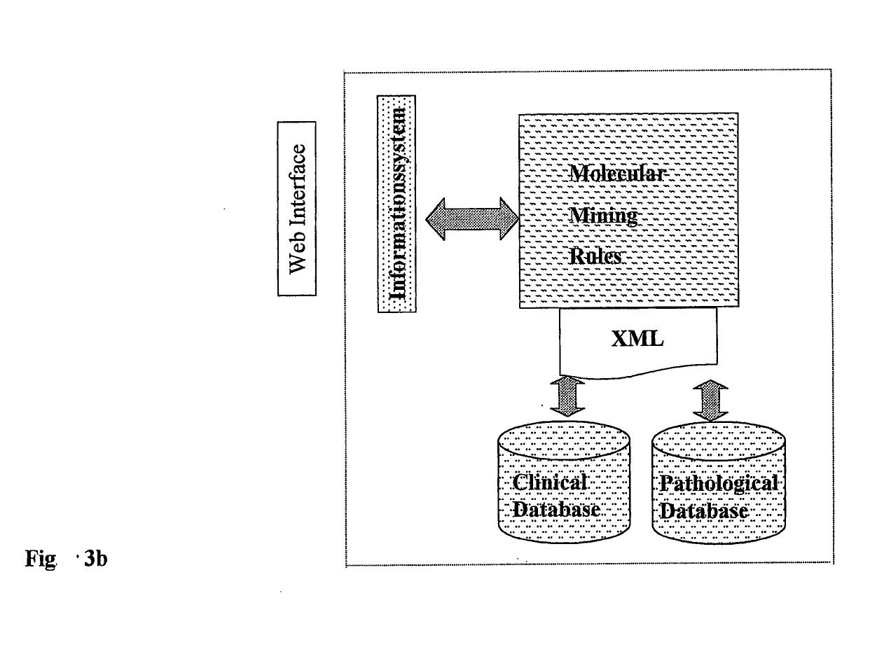

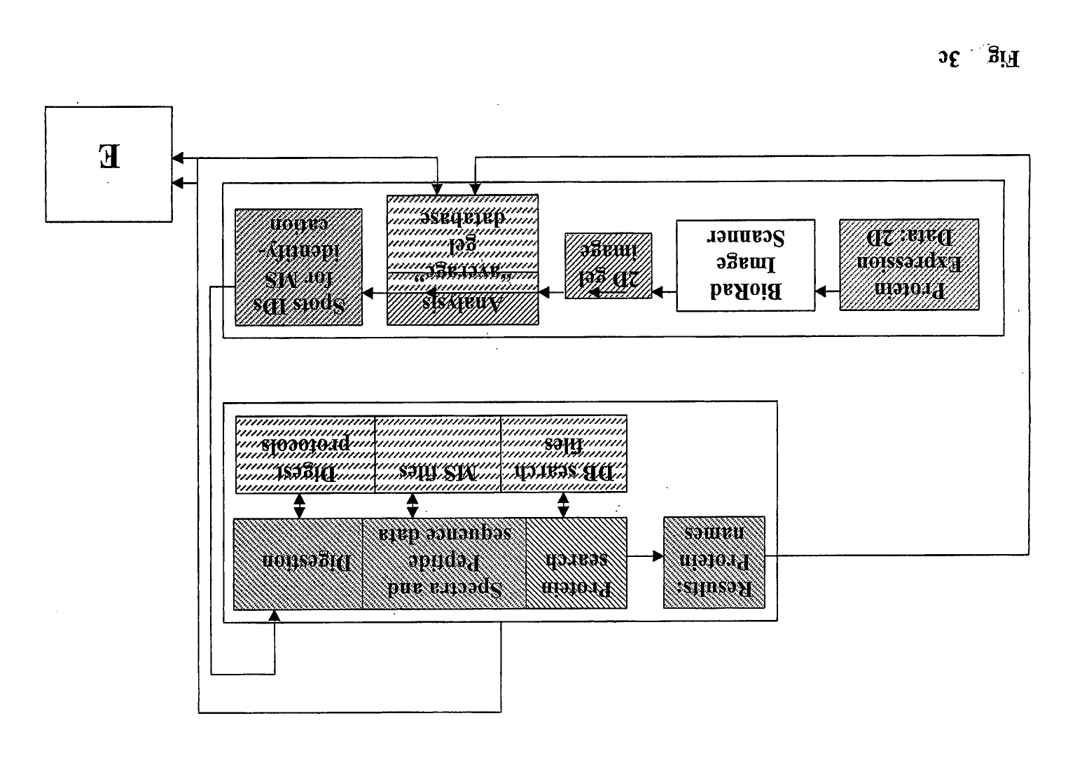

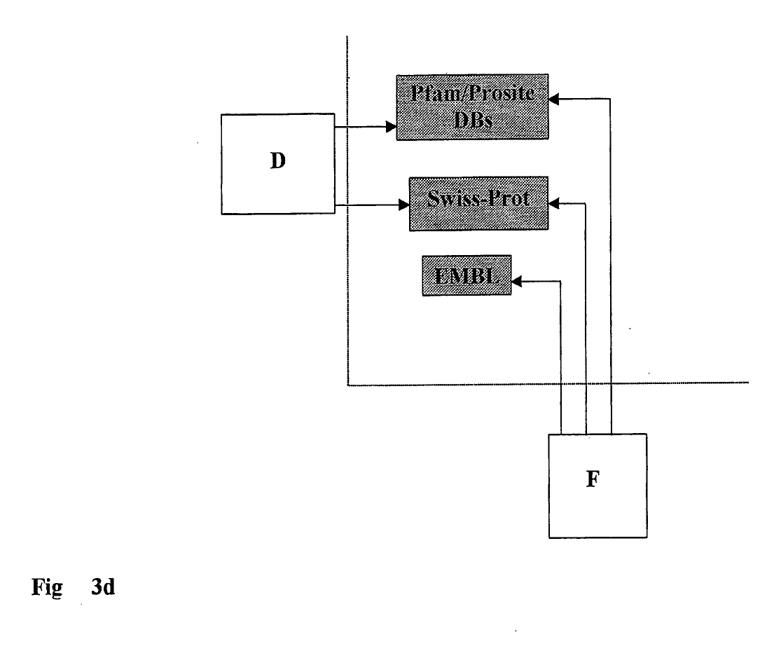

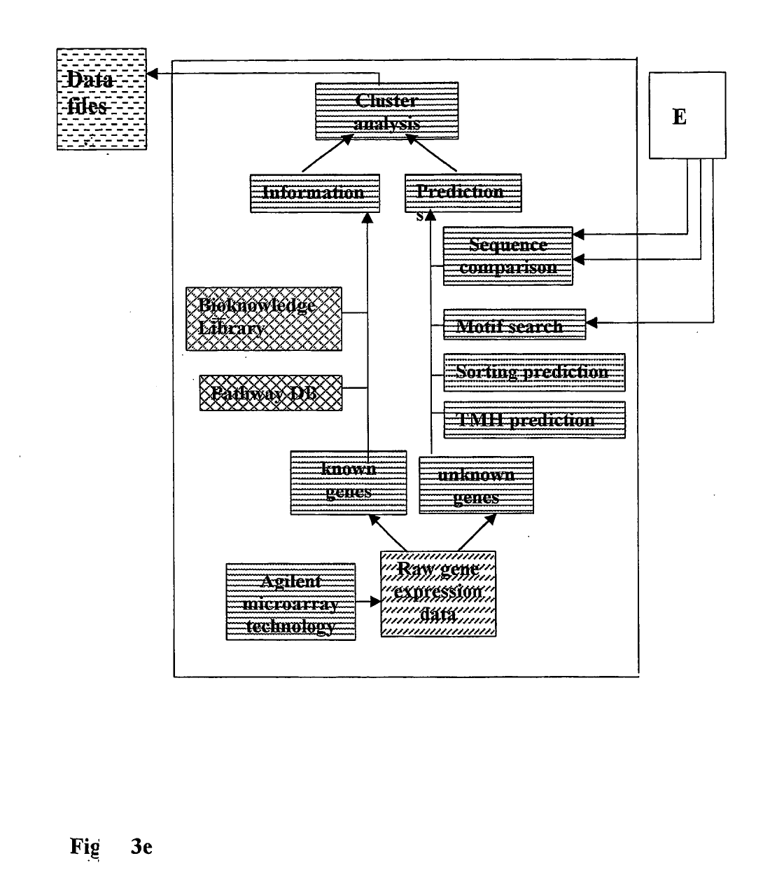

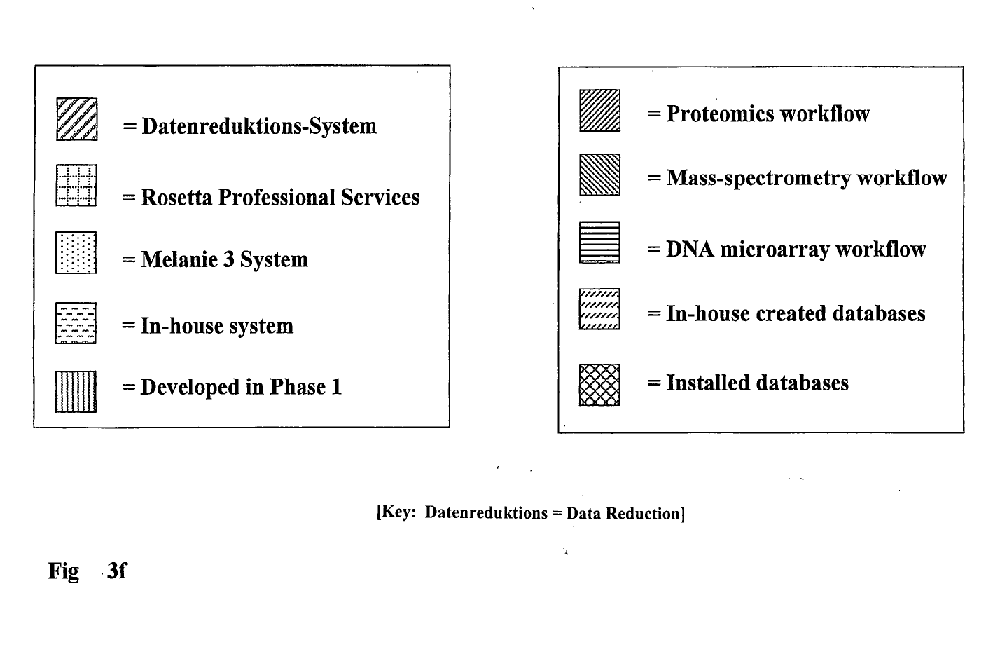

FIGS. 3a-f show a detailed visualization of the modular design of a medical information system,

FIG. 4 shows a visualization of the observed survival periods of various patient groups and estimates according to Kaplan-Meier of the number of patients with five-year survival periods,

FIG. 4a shows a group of all patients in UICC Stage III,

FIG. 4b shows patients of the group from 4a who exhibit an additional feature (group 1), shown in comparison to the patients without this feature (group 0),

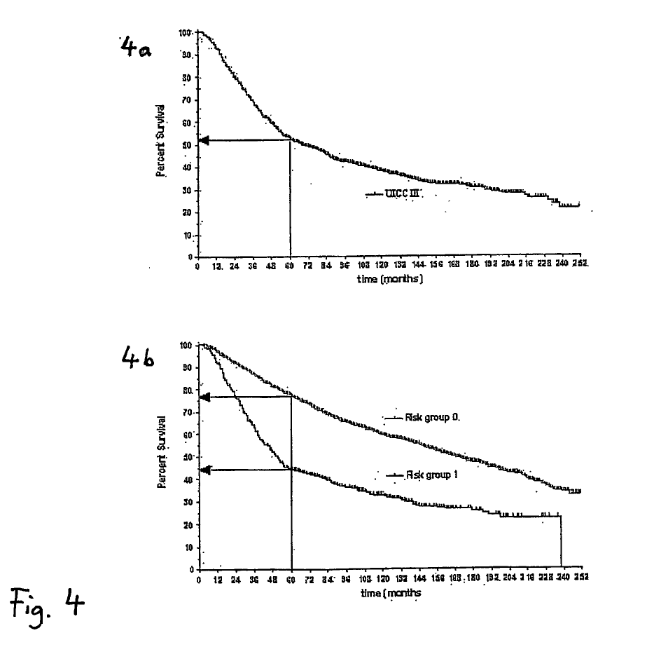

FIG. 5 shows a classification of patients within three different UICC stages in, in each case, two subgroups of high-risk patients and low-risk patients,

FIG. 5a shows UICC Stage I,

FIG. 5b shows UICC Stage 1I,

FIG. 5c shows UICC Stage III,

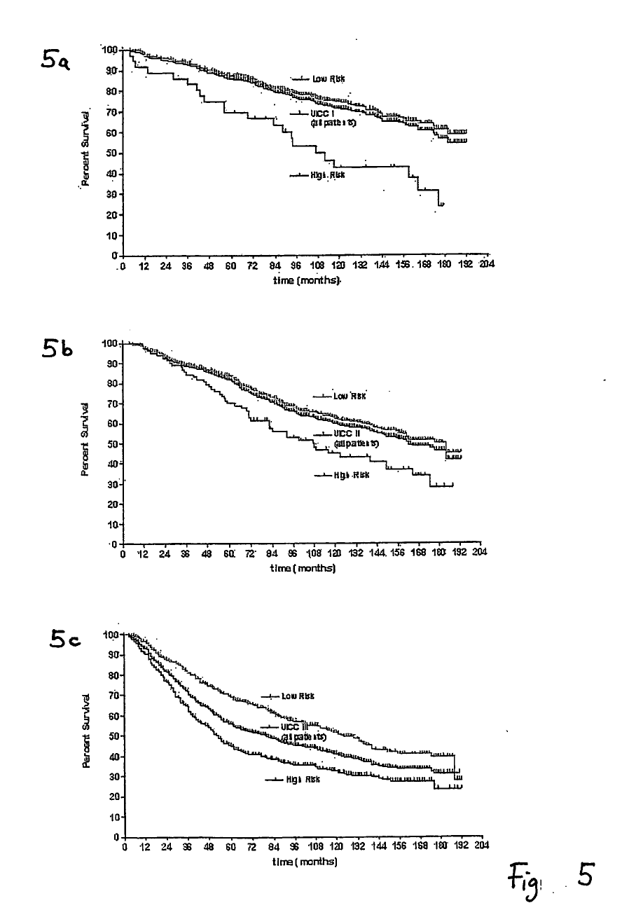

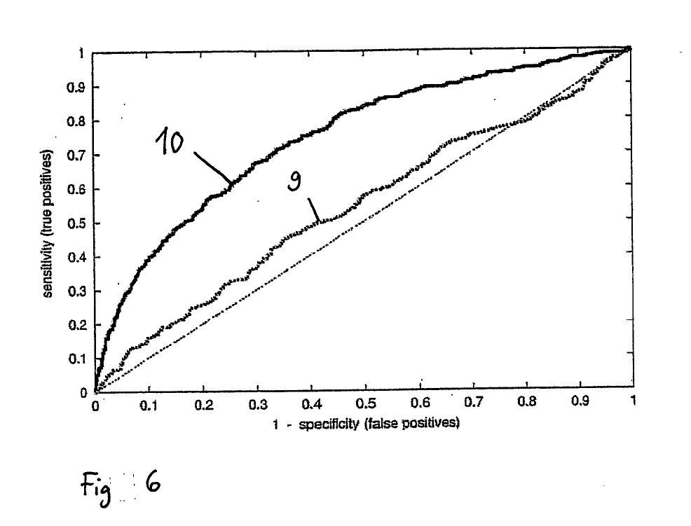

FIG. 6 shows an ROC-curve (ROC=Receiver Operating Characteristic) for a forecast while taking into consideration conventional information or with the incorporation of additional information obtained by the data evaluation according to the process according to the invention.

In the example of a medical information system for oncologists, in which an Internet-based patient-specific prognostic system was produced, use and mode of action of the invention are to be described.

The sample system is an Internet-based medical information system, which consists of databases, a data reduction program and modules of artificial intelligence (neuronal network or rule-based system). It allows the integration of clinical, pathological and biological data, and linkage thereof with relevant prognostic statements for a specific patient. This information system thus allows the oncologist to make an individual therapy decision based on specific information patterns. The therapy decisions are supported with probability calculations. As a prototype, the colorectal carcinoma was selected. The sample medical information system integrates data from the transcription and proteome research.

The application of the sample information system is described below. A patient visits a physician and inquires about treatment options for his cancer. After the operation, the oncologist sends the samples for analysis to a referral laboratory, and puts the item on account, where one or more laboratory tests are performed with any laboratory procedures, such as, for example, a chip, to implement the necessary gene expression analyses. With the sending of the samples, the oncologist receives a PIN number, thanks to which all relevant data of the patient (patient-specific, environment-specific, etc.) can be recorded in anonymous form in the database of the computer system according to the invention. Below this, the referral laboratory also records all tumor data provided with the PIN in this database. At the beginning of the use, a data set comprises all prognosis factors as variables that are accepted by the doctor for prognosis in colorectal carcinoma. Thanks to the PIN number, the correspondence of the molecular and clinical information can be found. This combined information is compared to the database, and the patient with the closest information pattern and course of disease thereof is selected. In this case, a retroactive error-minimization process is used. The physician (surgeon or oncologist) can then request various forecasts with the PIN in the information system. Within minutes, the latter then receives information on metastasizing probability, resistance profiles to various chemotherapy agents, and possibly to immunotherapy agents or the like. The thus obtained findings thus form an important decision assistance in the case of therapy decision. It is not intended now that patients receive direct access to the Website that allows for the access to the computer system according to the invention, but this possibility is kept open for the future. Later, the physician will consult the database regularly on therapy and course of his patient; these data are used for the iterative learning process of the system so that the latter can continuously match the medical progress. As a result, significant and insignificant variables are determined, which leads to an optimization of the amount of data to be evaluated and to the improvement of the prognosis. By way of example, this differentiation between significant and insignificant variables is carried out in that the information system examines the accuracy of the prognosis while taking the new variables into consideration. If this accuracy is improved, the new variable is considered to be significant. In other cases, it is classified as insignificant and discarded.

Regarding the understanding of the origin and linkage of data, it must be illustrated that the most significant data now available from clinical practice, pathology, and the treatment that has optionally already taken place allow one to make a prognostic statement. This prognosis was optimized in the sample information system for the colorectal carcinoma by modem bio-informatics. This system has achieved a prognostic output that could accurately be determined in hundreds of patients by cross-checking. The incorporation of new (molecular biological) data allows the system to “train” again. If the prognostic output rises, the new data are evaluated as prognostically significant and are required for further analyses. If the system with this set of new data is not better, these data are eliminated. Biological data can thus be selected extremely efficiently. With data-mining systems, e.g., selection processes are available that make this possible.

In FIG. 1a or 1b, the data evaluation according to the invention is opposite to the conventional process. While in a conventional process (cf. FIG. 1a), input variables 1 are processed immediately in a module 2 for calculating the correlation and then in a module 3 for multivariant statistical analysis (or regression analysis), a transformation step 5 is performed in the process according to the invention (cf. FIG. 1b) after input variables 1 are read in. Transformation step 5 is an important step of the process according to the invention and is used therein to avoid non-linearity of the process to keep the computing expense small. Herein, the symbolic variables are converted into suitable form. In subsequent feature section 6, the variables with the maximum information content are determined in succession. This is carried out until the corresponding weighting was assigned to each variable. As the next step, the training and the selection of model 7 follow. This process step contains the training of various models with various input variables and a number of concealed neurons, which were calculated, for example, according to the Bayes' evidence hypothesis. The best model 8 that was determined in this way can now calculate the prognoses for new patients, i.e., to determine an output value for new input data. Model structure 8 can always be further improved and matched (the model “learns”). Results 4b, which are achieved with use of the process according to the invention, are distinguished from results 4a that can be achieved by the conventional process by a higher prognosis quality, which is achieved primarily by drawing up patient-specific, individual risk profiles.

A considerable advantage of the process according to the invention for data evaluation thus consists in that patient-specific, individual risk profiles can be drawn up by, in addition to the clinical-pathological data—as mentioned—additional new molecular-biological data being considered. As FIGS. 4a and 4b clearly show, the process makes it possible, by the use of a data-mining system, to determine those data or features—so-called classifiers—in particular molecular-biological features, not contained in the data sets of the clinical data, which result in a differentiation of the risk groups within the UICC groups.

When taking into consideration a thus determined feature/classifier, i.e., after corresponding training of the system, prognoses for these two subgroups can be carried out much more accurately. Here, in the example of FIG. 4b, the deviation for the prediction of a five-year-survival period for the patient group without this feature is around 25% upward relative to the entire group, and for the group of patients who exhibit the feature, the prognosis for the five-year-survival period deviates by 8% downward relative to the entire group. A prognosis is thus significantly more specific when using the data evaluation according to the invention by the automatic determination of significant features.

FIGS. 5 and 6 illustrate in detail by various graphic visualizations how the prognostic quality can be significantly improved when the prognoses are based on additional data that were determined with the aid of the data-mining system of the invention.

Another more accurate classification can be performed, if necessary, within the UICC classes, if feature-selection 6 and training 7 of the neuronal network are applied only to one UICC class alone. FIGS. 5a-c show the results in the application to patients of UICC Stage 1 (FIG. 5a), in patients of UICC Stage 1I (FIG. 5b) and in patients of UICC Stage III (FIG. 5c). In all cases, it is clear that the application of the data evaluation according to the invention to special patient groups allows a further significant classification.

ROC curves illustrate the quality of a prediction. In this case, the “sensitivity” (i.e., the ratio of the correct predictions on the entry of an event to the total number of positive test results) is plotted on the ordinate against the complement of specificity (this is the proportion of healthy individuals with negative test results under all individuals with a negative test result). The quality of the prognosis is indicated by the area under the curve. Applied to the forecast of a 5-year survival period using only pre-operative (only clinical-pathological) data 9 and to prognoses with use of both preliminary data as well as additional data 10 that is determined by the data evaluation according to the invention (in particular, post-operative data turned out to be important here), FIG. 6 makes clear that the consideration of this additional data quite considerably improves the quality of the prognosis.

It is of special importance in this case that only those data in the evaluation that actually improve the quality of prediction (features selected by the feature selection) are included by the invention. Thus, the gigantic amount of molecular-biological data, which are already available now, can be processed.

In contrast to clinical tests, there are no standards for prognosis factor studies. Almost all prognosis factor studies unfortunately have a tendency to explain rather than to prove. It is therefore important for clinical researchers to define standards for the evidence of a prognosis factor before it is used in practice. The following guidelines should apply and are based on the inventive system:

the reproducibility of the study in in-house laboratories and in other laboratories,

the study regardless of the result (assay blinded to outcome),

less than 15% of the patient data should be missing,

uniform treatment,

hypothesis in advance,

sufficient patients (>10 per event),

the knowledge at this time is supplemented by predictions by new factors,

matched analyses of the various hypotheses,

study limitations must be specified in advance.

These guidelines are important not only for studies, but rather also for the success of a prognosis factor. They were considered in the inventive system. The acknowledgement of a new factor can only be successful if at least one substantiated study exists and if the studies can be reproduced in several clinics. The prognosis value should go beyond the previous standard prognosis factors, and it must have effects on the therapy.

To determine a prognosis, one should start from three prognosis factors:

tumor-related factors: characterize the disease,

patient-specific factors: relate to the patients,

environment-specific factors, which relate neither directly to the patients nor to the tumor.

In this case, the following points should advantageously be considered, whereby the latter can be supplemented, if necessary, according to new findings.

Tumor-Specific Factors

These factors are actually always the determinants, the specific factors for the result in cancer patients. The most important tumor-specific factors relate to histological information (type, features) and the anatomical propagation of the disease.

Pathology of the Tumor

The tumor pathology is decisive for the prognosis in cancer. The histological type defines the disease, but other factors, such as, e.g., the stage or the attack of lymph nodes, influence the result.

Propagation of the Disease

The anatomical propagation of the tumor is described usually according to the criteria of the TNM classification regarding size, infiltration of the primary tumor, existing lymph node metastases and satellite metastases.

Tumor Biology

Previously, cancer-specific proteins were used only as tumor markers to reflect the tumor load, without, however, being able to characterize the tumor behavior exactly. More recent results in tumor biology have allowed the focus to shift back to the prognostic role of tumor-specific proteins. As gene products, they can determine, i.a., causes and suppression of cancer, the normal and abnormal monitoring of the cell cycle and metastasizing and angiogenesis of the tumor. New technologies in molecular diagnosis now make it possible to determine genetic information that is related to minimum tumor load, aggressive tumor cell growth and tumor reaction as a result of changes in DNA or immunotherapies.

Tumor-Specific Symptoms

Although they can also be regarded as patient-specific, the actual cause of symptoms in oncology is the invasive nature of the tumor. Indeed, symptoms in most cancer patients are a very important prognosis factor. Classic examples of the action of symptoms are the B-symptoms (night sweats, fever and weight loss).

Patient-Specific Factors

These are factors that are present in patients that are either indirectly malignant or not at all malignant and that, however, may have a great influence on the result through an interference with the tumor behavior or their reaction in the treatment. Here, distinctions are made between demographic factors, co-morbidity rate and diseases that exist at the same time.

Demographic Factors

These factors, which have an effect on the oncological result, are age, gender and ethnic affiliation. None of these factors can be influenced by an intervention or a treatment, but many other factors, independently of one another, influence the result. For example, older patients have a lower survival period in the case of Hodgkin's disease or in the case of lymphoma.

The role of gender is far less accurately defined, but in the case of Hodgkin's disease or malignant growths, the results in men were worse than in women.

Co-Morbidity Rate

These factors can be inherited genetic diseases, such as, e.g., neurofibromatosis, which produce a risk factor for neurogenic sarcomas and a prognostic factor for cancer results.

Performance Status

The performance status is a strong prognostic factor for many types of cancer, especially in those in the advanced status, such as, e.g., lung cancer and bladder cancer, which require chemotherapy. As a result of the age or the co-morbidity rate, these factors should be regarded as patient-specific factors.

Similarity

Similarity to a proposed cancer preventive medical examination or treatment plan can influence the survival rate of a patient or a group of patients. Deficient similarity to cancer prevention recommendations in the case of breast cancer can result in a late diagnosis, a further advanced stage in the diagnosis and a lower survival rate.

Environment-Specific Factors

Although the environment-specific factors were less studied and often not included in the discussions, they have an influence on the result for an individual patient or an entire group of patients.

Medicine

The treatment plan has a far-reaching effect on the result. Inadequate interventions can end in excessive toxicity and limited quality of life. Failed control of the cancer can also mean death for the patients. The expertise of the attending physician is another prognostic factor, since it also influences the result in the cancer patient. There is increasing evidence that clinics that do not treat any specific number (“critical mass”) of patients also do not achieve any optimum treatment results.

Public Health Services

Here, there are great divergences between individual populations. Several studies have confirmed that, e.g., older men (75 years and older) or patients from other ethnic groups do not receive the same treatment as, e.g., younger or native patients and thus their treatment result is affected.

Social Position

Studies of the Office of National Statistics (GB) have shown that the survival in the case of a cancer is based on the socio-economic position of the patient. Another factor for a worse prognosis is nutrition.

For the gene expression profiling on the level of RNA and protein, purified samples and clinical data from colorectal patients, of which the necessary data are available, are analyzed, and the transcription and proteome profiles are determined therefrom. To this end, a number of deep-frozen samples from various colorectal patients from various institutions are available.

These samples were taken in particular for this purpose and are characterized by an excellent quality and reproducibility. The portion of epithelial cells varies considerably between various preparations (Reymond et al., Electrophoresis 1997a). For the sample preparation, a method was developed that allows the preparation of pure epithelial cells in a sufficient amount (over 10⁸ cells) from surgical preparations (this method is described in, e.g., UK Patent Application GB 9705949.7). From these samples, both proteins, and RNA can be prepared, which can be compared qualitatively with products from cell lines.

The samples that are prepared according to this method can be compared even if they come from different institutions. Thus, a basic condition is met to later compare the predictive statements of the system that is described here by way of example in different institutions. Thus, in the future, large sample throughput numbers can be achieved that are necessary for validation of gene expression research. Until now, several thousand samples were obtained from patients, in some cases with stools, blood and bone marrow puncture. The theoretical input of the clinical network, in which the sample information system is integrated, is several thousand new colorectal carcinomas per year.

These samples are associated with clinical-pathological data that are matched to the requirements of the sample medical information system, i.e., all parameters (variables) in each institution have been collected. The (common) follow-up diagram corresponds to the German guidelines.

The personal patient data are contained in the subscribing institutions that ensure the follow-up of the patients. Only anonymous data are sent on to the information system.

To implement a high-quality gene expression analysis, many techniques are now available with which one is able to analyze the expression level of each known gene on the level of transcription and proteome. A complete system for such analyses comprises, for example, the following components:

Transcription Analysis

The DNA Chips (DNA Microarrays): In principle, the cDNA chips are distinguished from the oligo chips. In the cDNA chips, about 300-400 bp long PCR products are attached to the chips. It is now possible to spot about 14,000 cDNAs in an array.

In the oligo chips, about 60 bp long oligonucleotides are synthesized on the chip surface. Arrays with 8,400 features, upon request also as a double array (16,800 spots), are produced. Specifically in the area of the DNA chips, new developments lead in a very short time to increasingly tighter arrays (higher number of spots) with a very great flexibility in the sequence selection.

The Microarray Scanner: New developments in the field of microarray scanners are able to analyze two fluorescence wavelengths simultaneously. At a resolution of 5 or 10 μm (can be adjusted by the user), the scanner requires about 8 minutes for scanning a chip. A 48-chip carousel allows the use of this system in high-throughput analysis.

The Bioanalyzer: The bioanalyzer is a Lab-on-a-Chip system, which is used for quality control primarily in RNA purification. With the aid of the bioanalyzer, the RNA that is purified by the experimenter is machine-analyzed qualitatively and quantitatively.

Proteome Analysis

With proteome techniques, the qualitative and quantitative expression of proteins can be determined in various stages of disease. Since, as is known, post-translational protein changes mean an important role in the clinical behavior of diseased cells, tissues and/or organs, these differences in the protein expression have an important influence in the application of the information system that is described by way of example.

As proteome techniques in the human colorectal carcinoma, e.g., an (SDS-PAGE) or two-dimensional gel electrophoresis (2D PAGE), N-terminal sequencing and mass spectrometry (MALDI-TOF and MS-MS) as well as chips, on which are applied antibodies, ligands or various surfaces to bind proteins, are used.

As sample technology for works in the field of proteome research, a combination of the two key technologies 2-D-gel electrophoresis and mass spectrometry is offered. The proteins are separated by means of 2-D-gel electrophoresis and then stained. The protein spots are cut, enzymatically digested, and the peptide mixture that is produced is examined by mass spectrometry. The protein is identified by means of a database adjustment of the resulting peptide mass fingerprints.

In this case, the mass spectrometry platform consists of an automatic sample preparation station, a high-performance MALDI-mass spectrometer (Matrix-Assisted Laser Desorption/Ionization Time of Flight) and a data station for automatic execution of the database searches. The MALDI-MS has high sensitivity and high mass accuracy; both are basic requirements for a successful protein identification. In addition, sequence information of the peptides can be determined by means of the PSD (Post Source Decay) technique.

To produce easier access to sequence information and to be able to determine specific post-translational modifications, the use of an electrospray-mass spectrometer is helpful. By the use of an automatic spot picker and a digester, an additional automatization can be ensured.

Another important object that must be achieved in the development of the medical information system according to the invention is the translation of the various information platforms (transcription and/or proteome data) in a common language.

To solve this sales problem, a bio-informatics concept was developed for the sample oncological information system, which allows it to integrate and to analyze data from clinical practice, from pathology, from DNA databases (such as, e.g., CGAP), from cDNA arrays (such as, e.g., Agilent Chips) and from the 2D PAGE. The various data from clinical practice, pathology, transcription and proteome research are translated into the web-based (*.xml) bioinformatics language GEML (Gene Expression Markup Language) (see http://www.geml.org).

Thus, the requirements for a true “bridging” of the various databases were established. This “bridging” can be considered as an absolute requirement for the assimilation of the experimental results of the gene expression in clinically useful information.

Now, after the data from clinical practice and from the laboratory have been converted to the *.xml format, a (standardized) database that contains about 10⁴ data can be accessed. These approximately 10⁴ data, which are now available for any patient, can in no way be imparted directly to the oncologist. For this reason, software that supports an evaluation of this abundance of information must be integrated in the information system according to the invention.

Processes for data reduction are used as components of the sample oncological information system. In this case, available data reduction software must be matched to the special requirements of the oncological evaluations. The approximately 10⁴ data per patient are reduced to 10² by the use of this software.

The digitalized proteome or transcription images that are produced by the scanner are processed in a compatible analysis program. This program can evaluate the gene expression data and store it. The program keeps records of each gene expression pattern and allows comparisons of various experiments. To this end, i.a., database queries in outside as well as inside databases are necessary. The program generates technology-specific error models. The probability values of each measurement that are generated from the error models are propagated via the entire analysis environment, which makes possible a higher predictive value in cluster analyses, similarity searches and tendency analyses. By special information-technology tools, the program makes it possible to perform analyses on Exon, sequences, cluster intensity and calculations of ratios. Clustering analyses contain, for example, agglomerative, division-value, mean-value and median-value algorithms. A sample information-technology process makes it possible to research patterns that are similar to the pattern of interest within all data sets of the database. Also, time sequences, by way of example in an iterative aftercare measurement, can be represented by a time line, by which specific behavior can be identified. Special search machines allow a quick database query and can be matched to an internal database. Also, hypertext links can be formulated such that compounds with internal or external databases can be produced.

By this procedure, it is achieved that only the biological data that show a significant behavior for a specific clinical observation are considered and are included for the evaluation. As a result, a considerable data reduction is achieved relative to conventional medical information systems.

The bio-informatics is supported in addition in that clinical outcomes (such as the metastasizing capacity or the therapy resistance of a specific tumor) can be connected directly to data patterns after the clinical-pathological data are taken into consideration. This interpretation can be simplified by, e.g., artificial intelligence and/or machine learning processes. Conventional computer programs comprise an amount of explicit instructions that say exactly to the program what and how it is to implement a calculation. Systems of artificial intelligence (KI systems) work under completely different requirements: knowledge is imparted to the program rather than exact instructions being given for processing. This passes through during the training phase of the KI system. By the KI system being used repeatedly for historical data and the results of these evaluations (“conclusions”) being compared to the actually existing facts, the behavior that is conveyed by the “finish-designed” system is learned in the course of this training.

The correspondence analysis hypothesis and the increasing hierarchical classification, which are used in the information system according to the invention, deviate significantly from the more classical hypothesis of the discriminance analysis by means of main component analysis. Beginning with a number of experiments, whereby each experiment has a large number of data points, the correspondence analysis yields a factorized space of reduced size for the representation of samples. The rising hierarchical classification sorts the images into informative groups. The simultaneous visualization both of spots and of chip-formers or gel-formers takes place in the same factorized space. The characteristic gene or protein representatives of a specific class of gels (e.g., cancer metastasis samples) are precisely labeled, which considerably simplifies the analysis. Consequently, the software can automatically classify protein or gene patterns, whereby in this respect, main component analysis corresponding to the respective requirements, wavelet analysis, artificial neuronal networks, heuristic cluster formation analysis and others can be used individually or in combination.

To be able to analyze the parameters selected by the software over a large area and at low cost, a reproducible laboratory test is performed.

This laboratory test allows the combination of outcome-relevant genetic, translational or functional characteristics of a tumor. This procedure makes it possible to use so-called integrated health care solutions, where the therapy is coupled to the diagnosis.

Such a laboratory test (or else several laboratory tests) can be performed, for example, with a chip. The chips exhibit the following properties:

the chip yields data on the metastasizing potential,

the chip yields data on the therapeutic response in the case of at least 10 popular chemotherapy agents,

the chip yields data on patient metabolism (e.g., enzymatic apparatus),

the chip yields information on anti-tumor autoimmunity,

the chip contains no more than 10² different data (+doubles), and

the chip is reproducible.

A broad applicability of the chip is achieved by the reproducibility so that a reasonably priced production is possible.

Since the relevant biological data are distinguished depending on the diagnosis, a separate test must be developed for each diagnosis. The laboratory tests that result therefrom can in this case be significantly distinguished from those that are outcome-relevant in colorectal carcinoma. As a result, it is difficult to describe this laboratory test precisely.

For the data exchange between the attending physician, the referral laboratory(ies) and databases, the information system according to the invention comprises preferably multilanguage, secure web interfaces that make possible the connection with oncologists and referral laboratories in the case of the sample solution. With the structuring of the information system by means of the Internet standard XML (extensible Markup Language), the availability of clinically relevant knowledge regarding a specific medical problem in the workplace of the oncologist is improved.

The selected cryptographic basic technique of the sample oncological information system is the symmetric encodement. Here, highly efficient processes are available that ensure long-term security at a key length of, for example, 128 bits. Communication partners have a common key, the PIN number. The PIN number is provided on account only to the attending physician, so that the patient cannot receive direct access to the information of the information system.

As a more advantageous standard, for example, the AES (Advanced Encryption Standard) can be selected.

As a more secure storage site for the electronic identity of a specific oncologist, the cryptographic chip card is ideal, i.e., in the Public Health Services, the HPC (Health Professional Card, identity card for professions in the Public Health Services).

First, a platform is defined. This means that inputs and outputs are specified. For this purpose, determinations are made regarding information flow and the account statement model.

For this information flow, by way of example the HON Code of Conduct (HONcode) for medical websites is being transplanted to the health field (www.hon.ch/HONcode/German). Active contents such as Java scripts are eliminated, except in necessary applications such as the remote input of clinical and pathological data, anonymized with a PIN, and aftercare data.

Concrete measures have also been taken for the security of the server of the sample information system. Only the most necessary TCP services run on the server. The mail server is equipped with current virus filters. Client/server connections, also with anonymized data, are developed via SSL (Secure Socket Layer). For user authentication, sample X.509 certificates are used. In conclusion, the database of the sample information system is regularly backed up so as to be able to ensure a clean recovery after a disaster.

For commercial use of the invention, the operator of this information system can either set up a marketing structure himself or hire outside parties to handle sales, for example, referral laboratories, large pharmaceutical firms or Internet Content Providers. The latter in turn could offer the information system to the target audience for use. The referral laboratories, large pharmaceutical firms or Content Providers in this case represent the actual customers of the operator (“customers”); the target audience or users of the information system (“subscribers”) are, e.g., physicians who are dealing with cancers.

In this case, several advantages would be brought into play by this business idea. The operator must thus concentrate on only a few customers and could use, e.g., the developed marketing system of these large customers, which in the case of the large pharmaceutical firms extends to the individual physician. By the suitable selection of customers, the worldwide availability of the information system can be achieved.

The deduction of fees for the use of the information system should advantageously also be carried out via the customers and not directly via the individual subscribers from the target audience. In this case, depending on the requirement, a prepayment, payment by installments, fees for each use or fees based on a percentage of the revenue that the customer makes with the information system, could be arranged. Also, fees per “PIN,” which were issued to the subscriber of the target audience or customers, are conceivable. This PIN makes it possible for the subscriber from the target audience to access and use the information system; more precisely, regarding the patient-specific data that are linked to the PIN.

The subscriber receives the PIN by payment of a fee to the customers (“no money—no PIN”). In connection with the PIN, the subscriber receives a chip, on which the tests that are necessary for the analysis are contained. The requirements on the chip (type and number of tests contained) also arise from, i.a., the statements that the information system makes with respect to the significance of the variables. After introducing the patient sample, the chip is then sent to a referral laboratory, and the evaluation is carried out in the above-described way. It is also conceivable that the patient sample from the subscriber is sent directly to the referral laboratory and only there is attached to the chip. The PIN would then be sent to the subscriber from the referral laboratory together with the test results. The price for the use of the information system would contain the chip in the total price for the purchase.

If the subscriber from the target audience addresses a query to the information system, he is generally required to provide certain data, especially on the course of therapy, medication or course of the disease. These data are used, i.a., to optimize the system. Since the value of the system thus is increased, the rebating of a specific portion of the fees to the respective subscriber can possibly also be considered from this data input.

The invention is not limited to the embodiments represented here. Rather, it is possible, by combination and modification of the above-mentioned agents and features, to produce other embodiment variants without exceeding the scope of the invention.

### Legend

1 Input variables

2 Module for calculating the correlation

3 Module for multivariant statistical analysis

4a Results of the conventional process

4a Results of the process according to the invention

5 Transformation step

6 Feature selection

7 Training and selection of the model

8 Best model, model structure

9 Pre-operative data

10 Pre-operative data and additional data determined by the data evaluation according to the invention

1. Process for data evaluation with use of data processing devices that are coupled to databases, characterized in that the query data fed to the data processing device are analyzed by ensuring that the data that are stored in the database(s) are obtained according to rules that can be specified in advance and/or corresponding to the query data with artificial intelligence procedures, the quality of these corresponding data is evaluated automatically, and based on this evaluation, the related query data and/or corresponding data automatically determine for the query the significance of these query data and/or corresponding data, and the results of the evaluation, the evaluation of the quality, and/or the significance of the data is output and/or provided in a form that is ready for recall.

2. Process according to claim 1, wherein the data evaluation generates medical prognoses and the query data are fed to the data-processing device as clinical-pathological data by a physician and/or as biomolecular data by an analysis laboratory.

3. Process according to claim 1, wherein the query data and/or the data that are stored in the database(s) are considered
disease-related factors and/or
patient-specific factors and/or
environment-specific factors.

4. Process according to claim 1, wherein an updating of the empirical data stored in the database(s) is carried out by having data on the therapy and the course of the disease be fed to the data processing device in cases forecast by the data processing device.

5. Process according to claim 1, wherein an updating of the evaluation instructions in an iterative learning process is carried out, in which queries, query data, used in the evaluation of queries, data stored in the database(s), results of the evaluation and events actually occurring are considered.

6. Process according to claim 1, wherein based on the evaluation, the amount of the data that is stored in the database(s) is reduced.

7. Process according to claim 1, wherein based on the significance, the number of query data to be supplied and/or the amount of the data that is stored in the database(s) is reduced.

8. Process according to claim 1, wherein the evaluation by
cluster analysis, and/or
similarity search, and/or
tendency analysis, and/or
correspondence analysis, and/or
rising hierarchical classification, and/or
main analysis, and/or
wavelet analysis
is carried out in connection with probability values that are generated from error models and/or agents of artificial intelligence, such as
neuronal networks and/or
rule-based systems.

9. Process according to claim 1, wherein the data evaluation comprises the determination of the initial probability of events referred to by the query and/or by the corresponding data.

10. Process according to claim 1, wherein the significance of data is determined such that a query is evaluated a first time without considering this data and a second time while considering this data, the evaluations of the results of these two evaluations are compared to one another, and the measurement of the influence of the data relative to an improvement or a worsening of the second evaluation relative to the first evaluation is determined.

11. Process according to claim 10, wherein in the case of an improvement of the second evaluation compared to the first evaluation, the data are regarded as significant, and are considered in future evaluations,
in the case of a worsening of the second evaluation compared to the first evaluation, the data are regarded as not significant and are no longer used for future evaluations.

12. Process according to claim 1, wherein the supply of data, the queries and/or the release of the results is carried out over the Internet.

13. Arrangement with at least one processor, which is (are) set up such that a process for data evaluation can be performed, whereby the query data that are fed to the data processing device are analyzed by ensuring that the data that are stored in the database(s) are obtained according to rules that can be specified in advance and/or corresponding to the query data with artificial intelligence procedures,
the quality of these corresponding data is evaluated automatically,
and based on this evaluation, the related query data and/or corresponding data automatically determine for the query the significance of these query data and/or corresponding data, and the results of the evaluation, the evaluation of the quality, and/or the significance of the data is output and/or provided in a form that is ready for recall.

14. Arrangement according to claim 13, characterized by
at least one data processing device that is coupled to at least one database,
agent for data input and/or data output,
agent working according to rules that can be specified in advance and/or with artificial intelligence procedures for determining data that corresponds to query data fed to a data processing device and stored in the database(s),
agent for automatic evaluation of the quality of the corresponding data,
agent for automatic determination of the significance of the query data and/or corresponding data for a query.

15. Computer program product, which comprises a computer-readable storage medium, on which a program is stored, which makes it possible for a computer, after it has been stored in the memory of the computer, to perform a process for data evaluation, whereby the data evaluation comprises the process steps according to claim 1.

16. Computer-readable storage medium, on which a program is stored, which makes it possible for a computer, after it has been stored in the memory of the computer, to perform a process for data evaluation, whereby the data evaluation comprises the process steps according to claim 1.

17. Use of a process according to claim 1 for
evaluating clinical, pathological and/or molecular-genetic data,
determining the prognostic significance of clinical, pathological and/or molecular-genetic data,
selection of molecular targets,
estimating the individual risk, such as, for example, the risk of metastasizing of individual patients,
estimating the probability of the therapeutic response to, e.g., chemotherapy agents and/or
automatic generation of prognostic and/or therapy proposals.

18. Data, genes, molecular and/or genetic targets, which are made available by a process according to claim 1, by an arrangement according to the present invention, by a computer program product according to the present invention, by a computer-readable storage medium according to the present invention or a use according to the present invention.

19. Production process for diagnostic arrangements that comprises the steps of a process according to claim 1 and one additional step, in which a diagnostically effective analytical tool, such as, e.g., an RNA chip or a protein chip and/or a combination of genes, which were made available by a process according to the present invention, by an arrangement according to the present invention, by a computer program product according to the present invention, by a computer-readable storage medium 16 or a use according to the present invention, is put together.

20. Use of genes or combinations of genes, which were made available by a process according to claim 1, by an arrangement according to the present invention, by a computer program product according to the present invention, by a computer-readable storage medium according to the present invention or a use according to the present invention, for the preparation of a diagnostic compilation for classification of genetically induced diseases, tumors, i.a., and/or for predicting genetically induced diseases and/or for combining molecular-genetic parameters with clinical parameters and/or for identification of tumors by gene expression profiles.

21. Carrier elements, on which data, genes, molecular and/or genetic targets are provided, which are made available by a process according to claim 1, by an arrangement according to the present invention, by a computer program product according to the present invention, by a computer-readable storage medium according to the present invention or a use according to the present invention.

22. Carrier element according to claim 21, wherein the carrier element is designed as a chip, and provides
data regarding individual risk, such as, e.g., metastasizing potential, and/or
data on the therapeutic response to, e.g., chemotherapy agents and/or
data for patient metabolism and/or
information on autoimmunity, e.g., anti-tumor autoimmunity.

23. Carrier element according to claim 22, wherein the number of data provided on the carrier element does not exceed one hundred.

24. Carrier element according to claim 22, wherein the carrier element is designed as a reproducible chip.

25. Method for using a system for data evaluation according to claim 1, wherein the access to the system is made possible by a PIN that is subject to fees, whereby the PIN is associated with agents for detecting data that is to be input into the system and/or with agents for detecting material that is used to determine the data that is being input, and the user acquires the PIN by paying a fee.

26. Method according to claim 25, wherein the user acquires the PIN together with the agent(s) for detecting the data and/or the material when buying this (these) agent(s).

27. Method according to claim 25, wherein a PIN is linked to data that can be specified in advance and that is stored in the system, and the PIN only facilitates access to the latter with its linked data.

28. Method according to claim 25, wherein a distributor of the system for data evaluation reaches an agreement of use with at least one customer, and the customer(s) makes (make) the system usable for additional subscribers by issuing PINs that are subject to fees.

29. Method according to one of claims 25 to 28 claim 25, wherein
referral laboratories, and/or
pharmaceutical firms and/or
content providers
use the system for data evaluation as customers.

30. Method according to claim 25, wherein the fees for the use of the system for data evaluation are raised from the customers and are collected
for each use and/or
as a percentage in the sales that the customer makes with the system and/or
per PIN that is issued.

31. Method according to claim 25, wherein an agent for detecting material is a carrier chip for the samples that are required in a laboratory test—that can be reproduced, if necessary—such as, e.g., a DNA-microarray.

32. Method according to claim 25, wherein a user of the system for data evaluation acquires the PIN from a distributor of the system or from a customer of the operator.

33. Use of a system for data evaluation according to claim 1 for implementing profit or non-profit actions by physicians, claim 1 for implementing profit or non-profit actions by physicians, patients and/or firms that operate the system.

34. Use of a system for data evaluation according to claim 33, wherein an action is initiated by
subscribers and/or
suppliers
of the system.

35. Use of a system for data evaluation according to claim 33, wherein an action comprises
the development, maintenance, and/or marketing of an excellence network and/or
the distribution of therapies and/or
the selection of patient groups for clinical studies.
